(19) United States
(12) Patent Application Publication
(10) Pub. No.: US 2025/0276434 A1
(43) Pub. Date: Sep. 4, 2025

(54) Storage Trays for Modular Unit

(71) Applicant: Milwaukee Electric Tool Corporation, Brookfield, WI (US)

(72) Inventors: Jeffrey M. Flynn, Milwaukee, WI (US); Tyler J. Smith, Milwaukee, WI (US); Scott M. Hangartner, Richfield, WI (US)

(21) Appl. No.: 19/027,495

(22) Filed: Jan. 17, 2025

Related U.S. Application Data
(60) Provisional application No. 63/560,365, filed on Mar. 1, 2024.

(51) Int. Cl. B25H 3/02; B25H 3/06; B65D 21/02; B65D 25/10

(52) U.S. Cl. CPC B25H 3/023; B25H 3/06; B65D 21/0223; B65D 25/108

(57) ABSTRACT

Tool supporting trays for a modular storage unit are provided. The tool supporting trays are configured to pivotably engage to provide access to tools and/or tool accessories positioned on both trays. In various specific embodiments, an upper tray is stacked above a lower tray. The upper tray is pivotable in an upward direction, away from the lower tray such that a user can access tools and/or tool accessories supported by the lower tray without removing the upper tray from the modular storage unit.

### CROSS-REFERENCE TO RELATED PATENT APPLICATION

The present application claims the benefit of and priority to U.S. Provisional Application No. 63/560,365 filed on Mar. 1, 2024, which is incorporated herein by reference in its entirety.

### BACKGROUND OF THE INVENTION

The present invention relates generally to the field of tool storage systems and related devices. The present disclosure relates specifically to a device that includes a work surface and a coupling mechanism to detachably couple the device to another device or container, such as in a modular storage system.

Tool storage units are often used to transport tools and tool accessories. Some storage units are designed to incorporate further components to separate and support tools such as trays. The trays when combined with other storage trays providing a pivoting motion to allow access to a lower tray.

### SUMMARY OF THE INVENTION

One embodiment of the invention relates a modular storage system. The modular storage system includes a modular storage container. The modular storage container includes a housing, an internal compartment defined by the housing, and a lid coupled to the housing. The modular storage system further includes a first tray and a second tray. The first tray is positioned within the internal compartment, the first tray includes a channel defined by a bottom surface. The second tray is positioned within the internal compartment, the second tray includes a rod configured to be received within the channel of the first tray. The rod defines a pivot axis. The first tray is pivotable with respect to the second tray about the pivot axis. The first tray and the second tray are each configured to support a plurality of tools or accessories.

Another embodiment of the invention relates to a modular storage system. The modular storage system includes a modular storage container. The modular storage container includes a housing, a cavity defined by the housing, and a lid coupled to the housing. The modular storage system further includes a first tray and a second tray. The first tray is positioned within the cavity and the second tray is positioned within the cavity below the first tray. The first tray and the second tray are each configured to support a plurality of tools or accessories. The first tray is pivotably engaged with the second tray such that the first tray is moveable between a first, storage position in which the tools or accessories supported by the second tray are inaccessible and a second, open position in which the tools or accessories supported by the second tray are accessible.

Another embodiment of the invention relates to a modular storage system. The modular storage system includes a utility module. The utility module includes a housing and an internal compartment defined by the housing. The modular storage system further includes a first tray and a second tray. The first tray is positioned within the internal compartment and the second tray is positioned within the internal compartment below the first tray. The first tray and the second tray are each configured to support a plurality of tools or accessories. The first tray is pivotably engaged with the second tray. The modular storage system further includes a third tray positioned within the internal compartment and a fourth tray positioned within the internal compartment below the third tray. The third tray and the fourth tray are each configured to support a plurality of tools or accessories. The third tray is pivotably engaged with the fourth tray.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a top perspective view of a tool storage device, according to an exemplary embodiment.

FIG. 2 is a bottom perspective view of the tool storage device of FIG. 1, according to an exemplary embodiment.

FIG. 3 is a modular storage system including the tool storage device of FIG. 1, according to an exemplary embodiment.

FIG. 4 is a perspective view of tool trays positioned with the tool storage device of FIG. 1, according to an exemplary embodiment.

FIG. 5 is a perspective view of the tool storage device with the tool trays in a closed, storage position, according to an exemplary embodiment.

FIG. 6 is a perspective view of the tool storage device with the tool trays in an open, accessible position, according to an exemplary embodiment.

FIG. 7 is perspective view of the tool storage device with the tool trays in an open, accessible position, according to an exemplary embodiment.

FIG. 8 is a perspective view of the tool trays stacked, according to an exemplary embodiment.

FIG. 9 is a partially exploded view of the tool trays, according to an exemplary embodiment.

FIG. 10 is a cross-sectional view of the stacked tool trays taken along line 10-10 of FIG. 8, according to an exemplary embodiment.

FIG. 11 is a perspective view of a tool storage device, according to another exemplary embodiment.

FIG. 12 is a perspective view of the tool trays of FIG. 11 stacked, according to an exemplary embodiment.

FIG. 13 is a partially exploded view of the tool trays of FIG. 12, according to an exemplary embodiment.

FIG. 14 is a bottom perspective view of the tool trays of FIG. 13, according to an exemplary embodiment.

### DETAILED DESCRIPTION

Referring generally to the figures, various embodiments of moveable trays for use with a modular system are shown according to exemplary embodiments. The moveable trays are configured to be utilized for storage and/or organization within the modular storage units. As will be generally understood, storage accessories (such as trays, bins, etc.) that are stackable provide ample storage, but frequently leave some tools in inaccessible positions. Applicant has developed tool trays configured to engage with each other such that the upper tray is pivotable, allowing a user to access the tool stored in the lower tray. In various specific embodiments, the lower tray includes a rod configured to pivotally engage with a channel or cutout in the bottom surface of the upper tray. In this way, all tools in both the upper and lower stacked trays are easily accessible without having to remove the trays from the modular storage unit saving time and improving efficiency for workers searching through their tool box.

Additionally, in various specific designs, the upper tray supports a number of different sized tools, such as a set of wrench. The upper tray includes a plurality of channels extending along a longitudinal axis of the tool tray with the channels configured to support the set of tools. However, there are a number of tools that may be too long to store in the channels aligned with the tray. Applicant has designed the lower tray to include a plurality of recesses or channels extending on an angle relative to the longitudinal axis of the tray. Applicant has found the angled storage of the lower tray provides the ability to store larges tools or wrenches that cannot be stored in channels aligned with the tray. Therefore, Applicant believes the combination of trays (i.e., upper, and lower trays) allows for storage of an entire tool set including relatively longer tools and/or the ability to storage a variety of tools having various sizes and/or lengths.

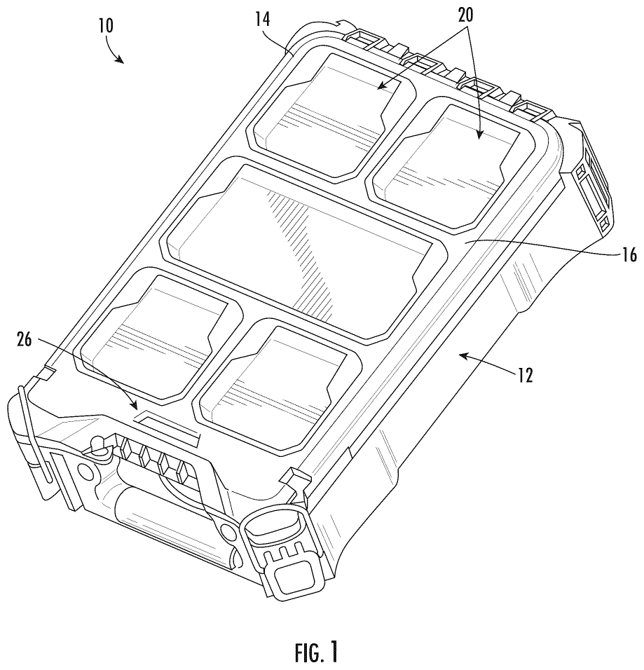

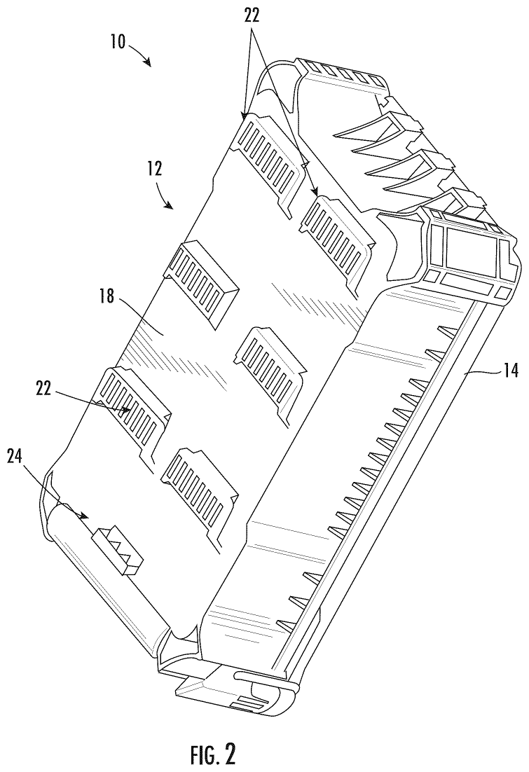

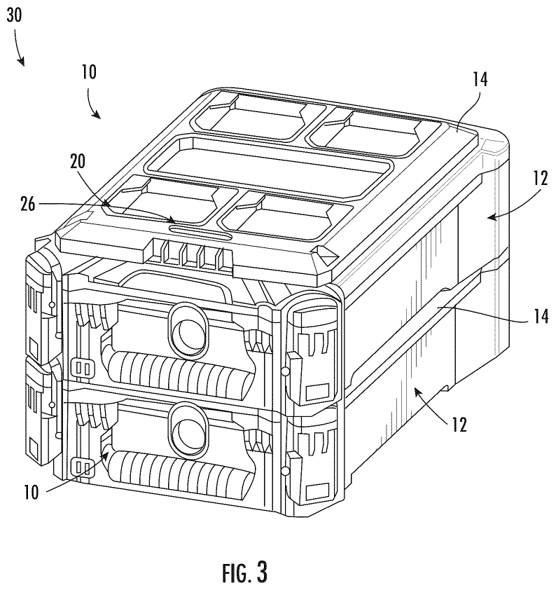

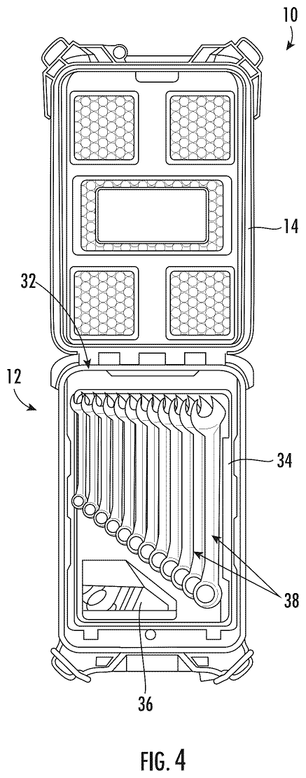

Referring to FIGS. 1-3, various aspects of utility module 10 are shown, according to an exemplary embodiment. Utility module or tool storage device 10 includes a lid 14 coupled to a housing 12. In various specific embodiments, lid 14 is pivotably coupled to housing 12 that defines an internal storage cavity or compartment 32 (see e.g., FIG. 4).

In various embodiments, utility module 10 includes one or more coupling interfaces, such as a first plurality of coupling components, shown as female couplers 20 and second plurality of coupling components, shown as male couplers 22, latches and/or recesses (see e.g., 24, 26) that are compatible with the coupling mechanism(s) described in International Patent Application No. PCT/US2018/044629, which is incorporated herein in its entirety. It is to be understood that various embodiments of the embodiments described herein utilize female couplers, male couplers, and/or latches as described in International Patent Application No. PCT/US2018/044629.

Lid 14 includes upper surface 16 and housing 12 includes an opposing lower surface 18 facing away from the upper surface 16. One or more female couplers 20 extend from and/or are located in upper surface 16 of utility module 10, and one or more male couplers 22 configured to engage female couplers 20 extend from lower surface 18 of utility module 10.

Utility module 10 includes a latch 24 and a latch recess 26 configured to interface with latch recesses 26 and latches 24, respectively, to secure utility module 10 to other objects and/or utility modules 10. When one or more utility modules 10 are stacked the male couplers 22 are engaged with the female couplers 20 of another utility module. Together the utility modules 10 and/or other modular storage contains, devices, and/or units form a tool storage system 30.

Referring to FIG. 4, one or more storage trays 34, 36 that can be utilized with utility module 10 are positioned within compartment 32. A first or upper tool supporting tray 34 is stacked or positioned above a second or lower tool supporting tray 36. Upper tray 34 is configured to support a plurality of tools, shown as wrenches 38. Lower tray 36 is similarly configured to support a plurality of tools and/or tool accessories.

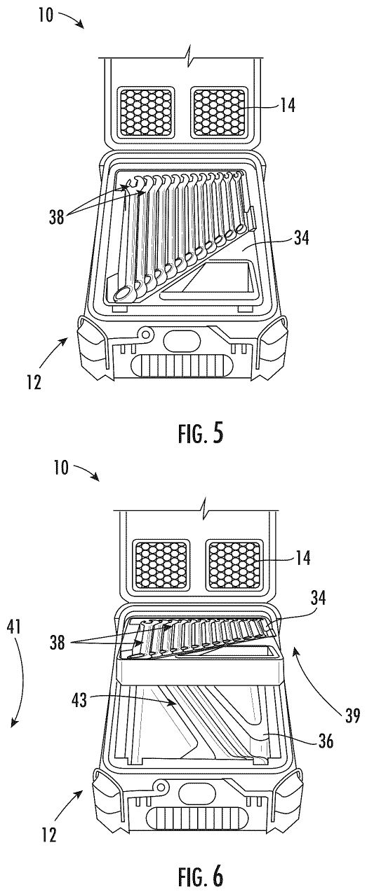

Referring to FIGS. 5-7, the movement of upper tray 34 relative to lower tray 36 is demonstrated. The pivoting movement of upper tray 34 in an upward direction (e.g., away from lower tray 36) is shown by arrow 39. Similarly, the pivoting movement of upper tray 34 in a downward direction (e.g., toward lower tray 36) is shown by arrow 41.

As shown in FIG. 5, when trays 34, 36 are in a first, storage position, upper tray 34 is stacked above lower tray 36 such that any tools supported on lower tray 36 are inaccessible. When upper tray 34 is pivoted in upward direction 39, upper tray 34 moves into a second, open position. In the open position, tools, shown as wrenches 43 that are supported by lower tray 36 become visible and/or accessible to a user. In other words, trays 34, 36 remain positioned within utility module 10 in both the storage position and the open position. As will generally be understood, this is in contrast to many storage trays that fold out or expand to a greater size than the utility module and/or storage cavity.

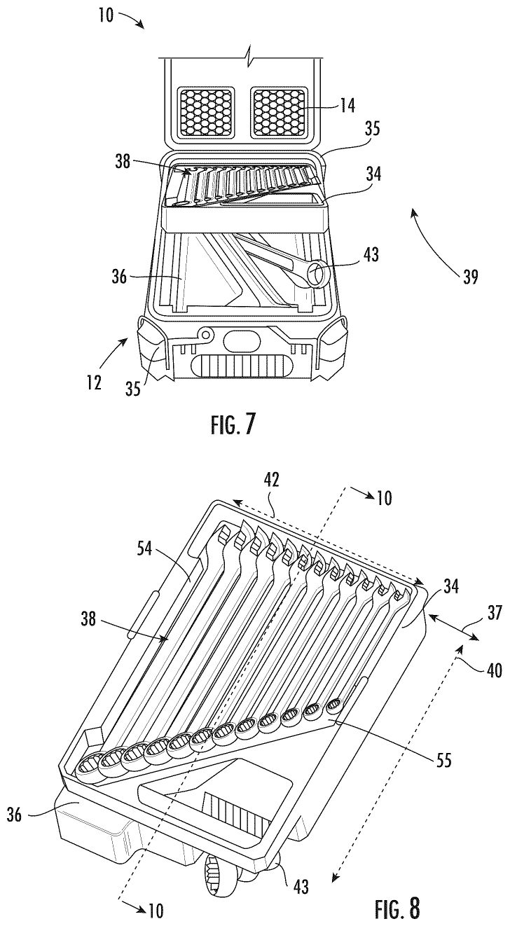

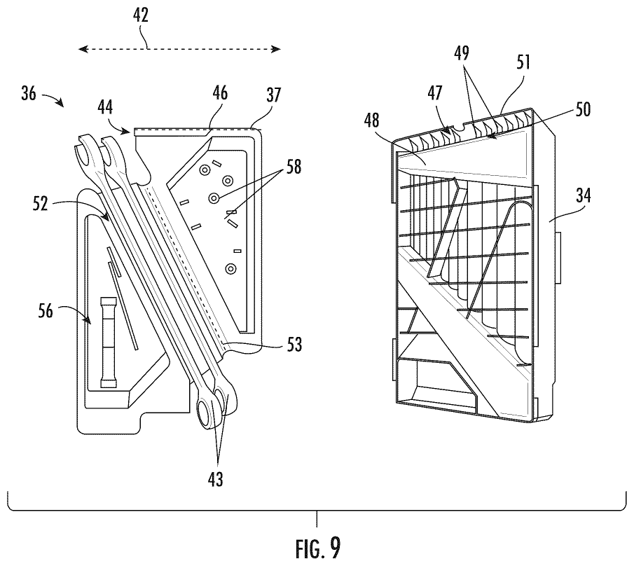

Referring to FIG. 8, details of upper tray 34 and lower tray 36 in a stacked orientation are shown, according to an exemplary embodiment. Upper tray 34 and lower tray 36 each extend along a longitudinal axis or major axis 40 in a first direction and a transverse or minor axis 42. Upper tray 34 pivots about a pivot axis 37 that extends in a parallel orientation to transverse axis 42.

Upper tray 34 includes a plurality of channels or sections 54 configured to receive and support tools such as wrenches 38. In a specific embodiment, each channel 54 is sized to receive a single wrench. In various specific embodiments, upper tray 34 includes one or more markings 55 to indicate the size of the wrench 38 positioned within each channel 54. Each of the channels 54 extends along and/or is aligned with longitudinal or major axis 40.

Referring to FIG. 9, details of the engagement components of upper tray 34 and lower tray 36 are shown, according to an exemplary embodiment. Lower tray 34 includes a protrusion or rod 44 configured to pivotably engage with upper tray 34. Rod 44 extends along a rear edge 46 of lower tray 36 and is oriented along transverse axis 42. In other words, protrusion or rod 44 extends along the minor or transverse axis 42 of lower tray 34. When lower tray 36 is stacked with upper tray 34, rod 44 is received within a channel or cutout 50 in upper tray 34. Cutout 50 is defined in a bottom or downward facing surface 48 of upper tray 34. Cutout 50 is positioned adjacent to a rear edge 51 and is similarly oriented along transverse axis 42.

As previously discussed, trays 34, 36 remain positioned within utility module 10 in both the storage position and the open position. In various embodiments, rod 44 or lower tray is positioned within utility module 10 and/or storage compartment 32 in the pivoted or open position. In various specific embodiments, rod 44 or lower tray remains entirely positioned within utility module 10 and/or storage compartment 32 in the open or pivoted position. In various specific embodiments, pivot axis 37 is positioned within the utility module 10 and/or storage compartment 32 in the open or pivoted position. In specific embodiments, pivot axis 37 is positioned entirely within the utility module 10 and/or storage compartment 32 in the open or pivoted position. As will be generally understood, this pivoting of upper tray 34 allows for easy access to lower tray 36 without requiring removal of upper tray 34 from utility module 10.

Lower tray 36 includes a plurality of storage channels or sections 52 configured to receive and support tools such as wrenches 43. Channels 52 each extend along a channel longitudinal axis 53. Channels 52 and channel longitudinal axis 53 are oriented at an angle relative to transverse axis 42 and longitudinal axis 40. In various specific embodiments, the channel longitudinal axis 53 is oriented at an angle between 0 and 90 degrees from transverse axis 42. In various specific embodiments, channel longitudinal axis 53 is oriented at an angle between 30 and 80 degrees, specifically between 45 and 75 degrees, and more specifically between 55 and 70 degrees relative to transverse axis 42. In a specific embodiment, channel longitudinal axis 53 is oriented at an angle of about 64 degrees (e.g., 64 degrees plus or minus 5 degrees) relative to transverse axis 42.

When lower tray 36 is positioned within housing 12, channels 52 and longitudinal channel axis 53 extend in a direction between opposing corners 35 of housing 12 (see e.g., FIG. 7). As previously noted, Applicant believes the angle of channels 52 allow for the storage of longer tools such as wrenches 43 that would be tool long to fit on a tray if positioned in an orientation that aligned with the longitudinal axis 40. Lower tray 36 further includes one or more recessed compartments 56. In a specific embodiment, recessed compartments 56 are positioned on opposing sides of the plurality of channels 52. Recessed compartments 56 are configured to receive and support smaller tools, accessories, and/or tool accessories 58 (e.g., fasteners, washers, etc.).

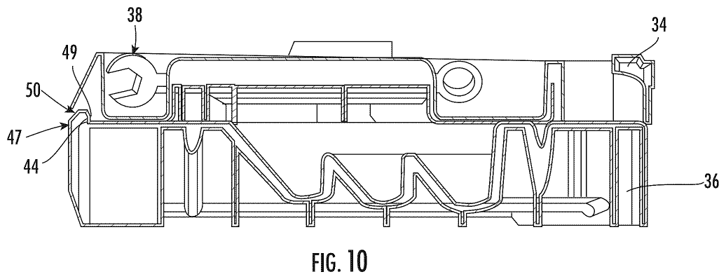

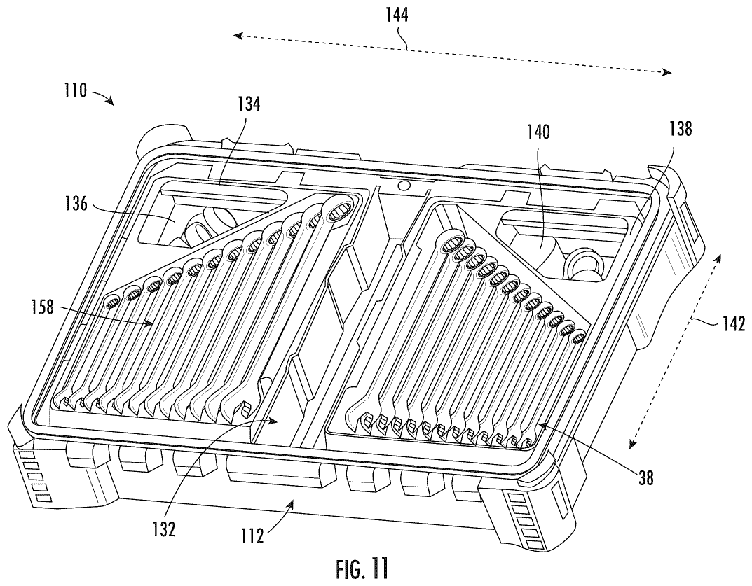

Referring to FIG. 10, a cross-sectional view of upper tray 34 and lower tray 36 taken along line 10-10 in FIG. 8 is shown. As can be seen, rod 44 of lower tray 36 is seated within cutout 50 of upper tray 34 to allow for the pivoting motion of upper tray 34 relative to lower tray 36. Rod 44 is received within an opening shown as elongate opening 47 of cutout 50 of upper tray 34 such that rod 44 and/or lower tray 36 is removably couplable to cutout 50 and/or upper tray 34. Elongate opening 47 extends along pivot axis 37 and transverse axis 42 when the upper tray 34 is engaged with lower tray 36.

Cutout 50 is further defined by one or more engagement surface 49 that interface against rod 44 during the pivoting of upper tray 34. In various embodiments, engagement surface 49 is curved. In a specific embodiment, engagement surface 49 has a concave shape relative to lower tray 36. As will be understood, elongate opening 47 and engagement surface(s) 49 allow for upper tray 34 to not only be pivoted relative to lower tray 36, but also to be lifted upward (e.g., in a generally vertical direction) to remove upper tray 34 from housing 12 when desired.

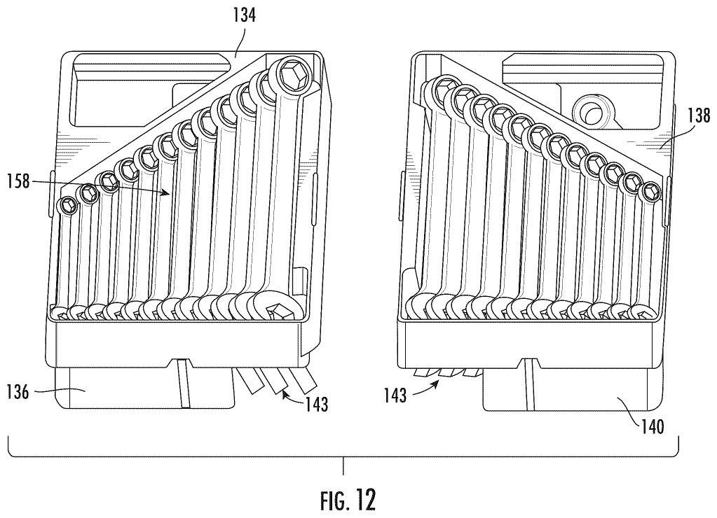

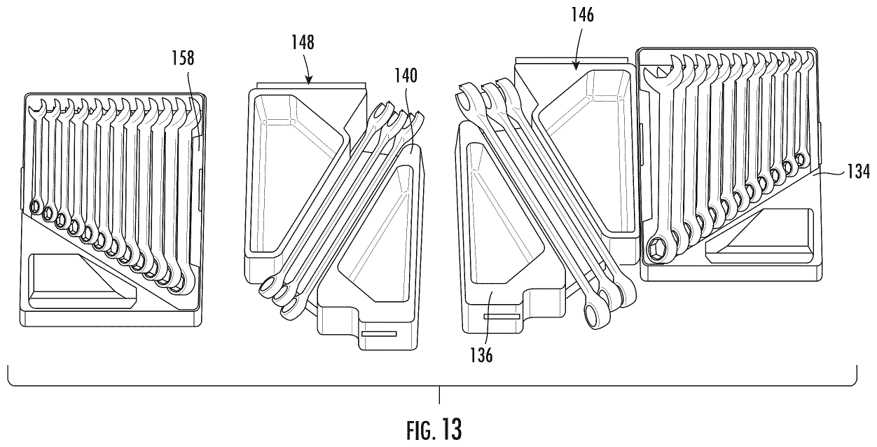

Referring to FIGS. 11-14, various aspects of a utility module 110 are shown, according to another exemplary embodiment. Utility module or tool storage device 110 is substantially the same as utility module 10 except for the differences discussed herein.

Compartment 132 of utility module 110 is relatively large compared to compartment 32 of utility module 10. As such, more than two tool supporting trays can be utilized with utility module 110. A first upper tray 134 is pivotably engaged with a first lower tray 136. First upper tray 134 is configured to support a plurality of tools, shown as wrenches 158. First lower tray 136 is similarly configured to support a plurality of tools and/or tool accessories.

A second upper tray 138 or third tray is pivotably engaged with a second lower tray 140 or fourth tray. Second upper tray 138 is configured to support a plurality of tools, shown as wrenches 158. Second lower tray 140 is similarly configured to support a plurality of tools and/or tool accessories.

In various specific embodiments, first upper tray 134 and second upper tray 138 are oriented side by side within compartment 132 such that a major axis of both first upper tray 134 and second upper tray 138 extend along a minor axis 142 of utility module 110. In various specific embodiments, a first major axis of first upper tray 134 is generally parallel (e.g., parallel plus or minus 10 degrees) to a second major axis of second upper tray 138. In other words, in such an orientation a major axis of first upper tray 134 and a major axis of second upper tray 138 are aligned with and/or extend along the minor axis 142 of utility module 110.

In other words, in such an orientation, the rear portions of first upper tray 134 and second upper tray 138 extend along a major axis of utility module 110. As will be generally understood, in various other embodiments, stacked trays may be positioned in different orientations based upon the size and orientation of the compartment of housing 112.

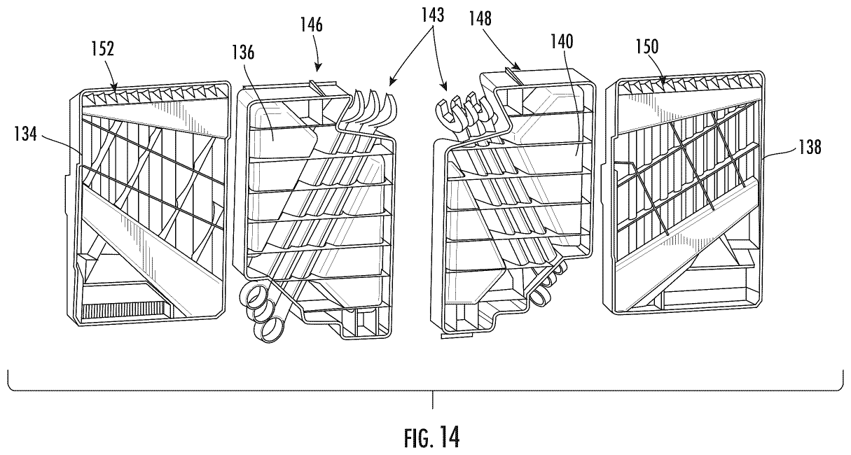

As shown in FIGS. 13-14, each lower tray 136, 140 includes a rod 146, 148 respectively to allow for pivoting engagement with a cutout 150, 152 defined in the respective upper tray 134, 138. In specific embodiments, when a first rod 146 of first lower tray 136 is received within the first cutout 150 of the first upper tray 134, the first rod 146 defines a first pivot axis. Similarly, when the second rod 148 of second lower tray 138 is received within the second cutout 152 of the second upper tray 136, the second rod 148 defines a second pivot axis. In such embodiments, the first pivot axis is aligned with the second pivot axis. In specific embodiments, the first pivot axis is collinear with the second pivot axis (see e.g., FIG. 11).

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A modular storage system comprising:
a modular storage container comprising:
a housing;
an internal compartment defined by the housing; and
a lid coupled to the housing;
a first tray positioned within the internal compartment, the first tray comprising a channel defined by a bottom surface;
a second tray positioned within the internal compartment, the second tray comprising a rod configured to be received within the channel of the first tray, the rod defining a pivot axis;
wherein the first tray is pivotable with respect to the second tray about the pivot axis, and wherein the first tray and second tray are each configured to support a plurality of tools or accessories.

2. The modular storage system of claim 1, wherein the rod extends along a rear edge of the second tray and is oriented along a minor axis of the second tray.

3. The modular storage system of claim 1, wherein the first tray is positioned between the lid and the second tray.

4. The modular storage system of claim 1, wherein the channel of the first tray further comprises one or more engagement surfaces that interface against the rod when the first tray is pivoted.

5. The modular storage system of claim 4, wherein the one or more engagement surfaces each have a concave shape relative to the second tray.

6. The modular storage system of claim 1, wherein the channel of the first tray defines an elongate opening, and wherein the elongate opening extends along a minor axis of the second tray when the first tray is engaged with the second tray.

7. The modular storage system of claim 1, wherein the second tray further comprises a storage channel extending along a channel longitudinal axis, wherein the channel longitudinal axis extends at an angle relative to a minor axis of the second tray and a major axis of the second tray, and wherein the storage channel is configured to support a tool or accessory.

8. The modular storage system of claim 7, wherein the channel longitudinal axis is orientated at angle between 55 and 70 degrees relative to the minor axis of the second tray.

9. A modular storage system comprising:
a modular storage container comprising:
a housing;
a cavity defined by the housing; and
a lid coupled to the housing;
a first tray positioned within the cavity;
a second tray positioned within the cavity below the first tray, wherein the first tray and second tray are each configured to support a plurality of tools or accessories;
wherein the first tray is pivotably engaged with the second tray such that the first tray is moveable between a first, storage position in which the tools or accessories supported by the second tray are inaccessible and a second, open position in which tools or accessories supported by the second tray are accessible.

10. The modular storage system of claim 9, wherein, when the first tray is moved into the second, open position, the first tray moves away from the second tray and toward the lid of the modular storage container.

11. The modular storage system of claim 9, wherein the second tray further comprises a protrusion extending along a rear edge of the second tray, and wherein the protrusion defines a pivot axis.

12. The modular storage system of claim 11, wherein the first tray further comprises a channel defined in a downward facing surface of the first tray, wherein the channel is positioned adjacent to a rear edge of the first tray.

13. The modular storage system of claim 11, wherein the protrusion is positioned within the cavity of the housing when the second tray is in the open position.

14. The modular storage system of claim 9, wherein the first tray further comprises a plurality of sections extending along a major axis of the first tray, wherein the plurality of sections are configured to support a tool or accessory.

15. The modular storage system of claim 14, wherein the second tray further comprises a plurality of sections extending at an angle relative to a minor axis of the second tray and a major axis of the second tray, wherein the plurality of sections are configured to support a tool or accessory.

16. A modular storage system comprising:
a utility module comprising:
a housing; and
an internal compartment defined by the housing;
a first tray positioned within the internal compartment;
a second tray positioned within the internal compartment below the first tray, wherein the first tray and the second tray are each configured to support a plurality of tools or accessories, and wherein the first tray is pivotably engaged with the second tray;
a third tray positioned within the internal compartment;
a fourth tray positioned within the internal compartment below the third tray, wherein the third tray and the fourth tray are each configured to support a plurality of tools or accessories, and wherein the third tray is pivotably engaged with the fourth tray.

17. The modular storage system of claim 16, wherein the first tray comprises a first major axis and the third tray comprises a second major axis, and wherein the first major axis is generally parallel to the second major axis.

18. The modular storage system of claim 17, wherein the first major axis of the first tray and the second major axis of the third tray each extend along a minor axis of the utility module.

19. The modular storage system of claim 16, wherein the first tray further comprises a first channel defined by a bottom surface, wherein the second tray further comprises a first rod received within the first channel of the first tray, the first rod defining a first pivot axis, wherein the third tray further comprises a second channel defined by a bottom surface, and wherein the fourth tray further comprises a second rod received within the second channel of the third tray, the second rod defining a second pivot axis.

20. The modular storage system of claim 19, wherein the first pivot axis is collinear with the second pivot axis.
